(19) United States
(12) Patent Application Publication
(10) Pub. No.: US 2008/0222475 A1
(43) Pub. Date: Sep. 11, 2008

(54) METHOD AND APPARATUS FOR COMPENSATING FOR PACKET LOSS

(75) Inventor: Gung-eun NAM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/872,129

(22) Filed: Oct. 15, 2007

(30) Foreign Application Priority Data
Mar. 9, 2007 (KR) 10-2007-0023673

(51) Int. Cl. G06F 11/14

(52) U.S. Cl. 714/747; 714/748; 714/E11.113

(57) ABSTRACT

A client, system, and method are provided to compensate for the loss of multicast data packets. When data packets transmitted to two or more clients are lost, a client determines whether compensation for the data packet is needed; if so, the client requests other clients to compensate, receives a compensated data packet, and performs packet rearrangement. To process a request for compensation for a data packet, a first client receiving such a request transmits the lost data packet to the second client so as not to collide with transmission by a third client which also received the request from the second client. Accordingly, if a client loses a data packet, it can be compensated for, preventing reproduction of multimedia data from interruption due to the loss. Also, since clients, not the server, compensate for the lost packet, it is possible to avoid interruptions in data transmission from the server.

### CROSS-REFERENCE TO RELATED PATENT APPLICATIONS

This application claims the benefit of Korean Patent Application No. 10-2007-0023673, filed on Mar. 9, 2007, in the Korean Intellectual Property Office, the disclosure of which is incorporated herein in its entirety by reference.

### BACKGROUND OF THE INVENTION

1. Field of the Invention

The present invention relates to internet protocol (IP) multicast, and more particularly, to an apparatus and method for compensating for a loss of data packets transmitted using IP multicast.

2. Description of the Related Art

Data packets can be sent through the Internet from a server computer (hereinafter referred to as “server”) to a client computer (hereinafter referred to as “client”) by various routing methods, including anycast, broadcast, multicast, and unicast.

As internet protocol (IP) televisions (TVs) or internet TVs have recently been developed, multicast has been used more extensively.

Multicast is a technique which allows the same data packet to be simultaneously transmitted from one source (or one server) to a plurality of clients which subscribe to a multicast group.

An example of the various multicast techniques is IP multicast, based on an IP infrastructure. According to IP multicast, clients that desire to receive multimedia content from a server form one multicast group, and share the same multicast address (or the same IP destination address). The server transmits a data packet that contains the destination address only once, via the Internet. Thereafter, routers in a network duplicate the data packet and transmit it to the clients which subscribe to the multicast group.

IP multicast allows a large amount of multimedia content to be simultaneously transmitted to a plurality of clients, and thus can prevent an information traffic jam that occurs frequently if unicast is used.

However, a client cannot reproduce a received image or audio data for a while if some data packets transmitted from an IP multicast server are lost or damaged owing to the bad conditions of a network or the temporary overload of a terminal, and particularly, if the lost or damaged packets are important or contain header information necessary to reproduce audio/video (AIV) data.

In order to solve this problem, Pragmatic General Multicast (PGM) has been conventionally used. According to PGM, a client accesses a server by unicast in order to request retransmission of the lost or damaged data packets. However, if the transmission rate of a transmission channel is high, retransmission of the lost or damaged data packet may be difficult, and retransmission of the lost or damaged data packet may interrupt the transmission of other packets by the server.

### SUMMARY OF THE INVENTION

The present invention provides a method and apparatus for compensating for a lost or damaged data packet of a client without interrupting a data transmission of a server.

According to an aspect of the present invention, a client is provided comprising a packet monitoring block which monitors whether data packets transmitted from a server which provides multimedia content are lost; and a compensation request processing block which transmits a request for lost data packets to other clients if the packet monitoring block detects lost data packets, and processes a compensation request for compensation of lost packets if the compensation request is received from at least one of the other clients.

According to another aspect of the present invention, there a system is provided to compensate for data packet loss, the system comprising a server which provides multimedia content; two or more clients forming a multicast group; and a network which electronically connects the server and the clients, wherein if one of the clients loses data packets transmitted from the server, the lost data packets are compensated for from the other clients.

According to another aspect of the present invention, a method is provided to compensate for lost data packets, the method comprising receiving, in a client, data packets; determining in the client whether compensation for data packets is needed; if compensation for data packets is needed, sending, from the client to the other clients, a request to compensate for data packet; and receiving in the client one or more data packets that are to be compensated for from the other clients, and performing packet rearrangement.

According to another aspect of the present invention, a method is provided to a request for compensation for a data packet, the method comprising determining in a first client whether a request for data packet compensation is received from a second client; and if the request is received, transmitting a lost data packet from the first client to the second client in a manner such that transmission by the first client does not collide with transmission by a third client which has also received the request from the second client.

According to another aspect of the present invention, d a multicast data packet is provided comprising a header section, and a data section, wherein the header section comprises continuity information and packet importance information.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic block diagram of a system for compensating for data packet loss, according to an exemplary embodiment of the present invention;

FIG. 2 illustrates the construction of a data packet supporting an apparatus and method for compensating for packet loss, according to an exemplary embodiment of the present invention;

FIG. 3 is a block diagram of clients that constitute a system for compensating for packet loss, according to an exemplary embodiment of the present invention;

FIG. 4 is a flowchart illustrating a method of compensating for data packet loss, according to an exemplary embodiment of the present invention; and

FIG. 5 is a flowchart illustrating in detail operation 45 of the method illustrated in FIG. 4, according to an exemplary embodiment of the present invention.

### DETAILED DESCRIPTION OF THE INVENTION

The present invention will now be described more fully with reference to the accompanying drawings, in which exemplary embodiments of the invention are shown.

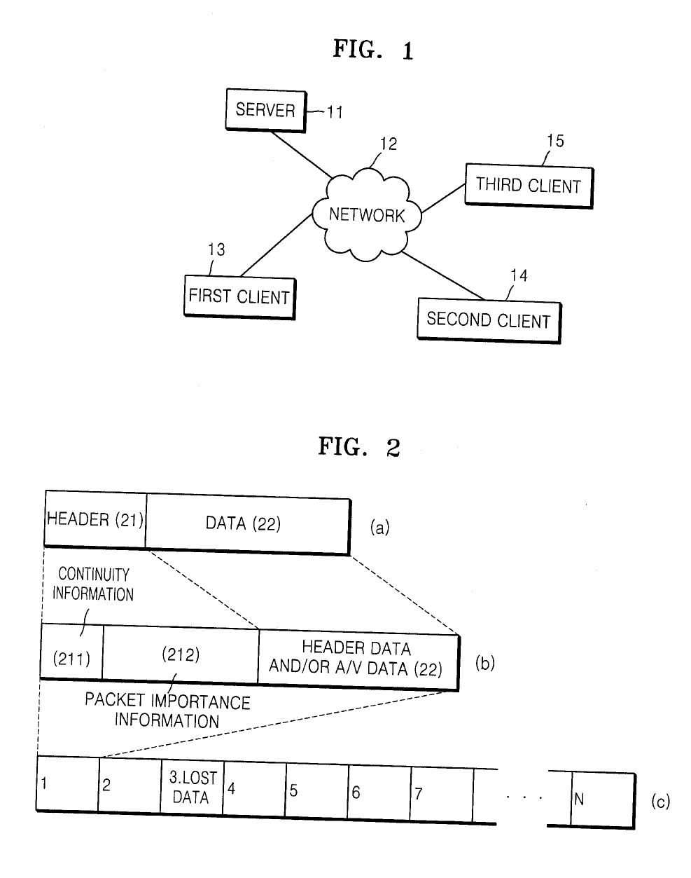

FIG. 1 is a schematic block diagram of a system for compensating for data packet loss, according to an exemplary embodiment of the present invention. Referring to FIG. 1, the system includes a server 11 that provides streaming services, and client computers 13, 14, and 15. The server 11 and the clients 13 through 15 are electronically connected via a network 12, e.g., the Internet. The system supports IP multicast. The server 11 provides the clients 13 through 15 with various multimedia content (or A/V data packets) using a streaming mode. Representative examples of the streaming mode are an IP TV service, and a video conference service.

In order to receive data packets from the server 11, the clients 13 through 15 subscribe to two multicast groups: one multicast group that allows them to receive data packets from the server 11, and the other multicast group that allows compensation for lost or damaged (hereinafter referred to as “lost”) data packets. In general, members of the latter multicast group are the same as those of the former multicast group, and internet protocol (IP) addresses, are allocated to both multicast groups. These IP addresses may be similar, e.g. 224.0.0.1 and 224.0.0.2, but are not necessarily limited to being similar or to having any particular relationship or particular values.

An example of a network through which the server 11 and the clients 13 through 15 are connected is an IP-based internet.

FIG. 2 illustrates the construction of a data packet supporting an apparatus and method for compensating for packet loss, according to an exemplary embodiment of the present invention. (a) of FIG. 2 illustrates the construction of a multicast data packet transmitted from a server to clients belonging to a multicast group. The multicast packet includes a header section 21 and a data section 22. (b) of FIG. 2 illustrates in detail the construction of the multicast data packet (a).

The header section 21 contains continuity information 211 and packet importance information 212. If the header section 21 is a routing table protocol (RTP) header, the RTP header is 12 bytes long, and the continuity information 211 and the packet importance information 212 are inserted into blank bytes of the 12 bytes.

The continuity information 211 indicates a sequence of numbers, e.g., 1-2-3 . . . -N-1-2 . . . , which are respectively given to a sequence of data packets, the sequence of numbers being repeated in a predetermined cycle N. The packet importance information 212 indicates whether a packet must be compensated for if it is lost or damaged. For example, the packet type may be used as the packet importance information 212. Thus, if a lost packet contains a header for reproducing A/V data and other important data, the system must compensate for that packet if lost. In this case, the packet importance information 212 may indicate the types of the current packet and a subsequent packet (or a previous packet).

The data section 22 includes header data and/or A/V data. The header data is needed to reproduce the A/V data.

(c) of FIG. 2 illustrates data packets of a cycle, which are arranged based on the continuity information 211. A sequence of numbers ranging from 1 to N are respectively given to the packets. Here, N is determined by a client memory size, a speed of processing a request from the system, the extent of packet loss, the speed of packet transmission, and so on. For example, the value of N may be N=FF in hexadecimal.

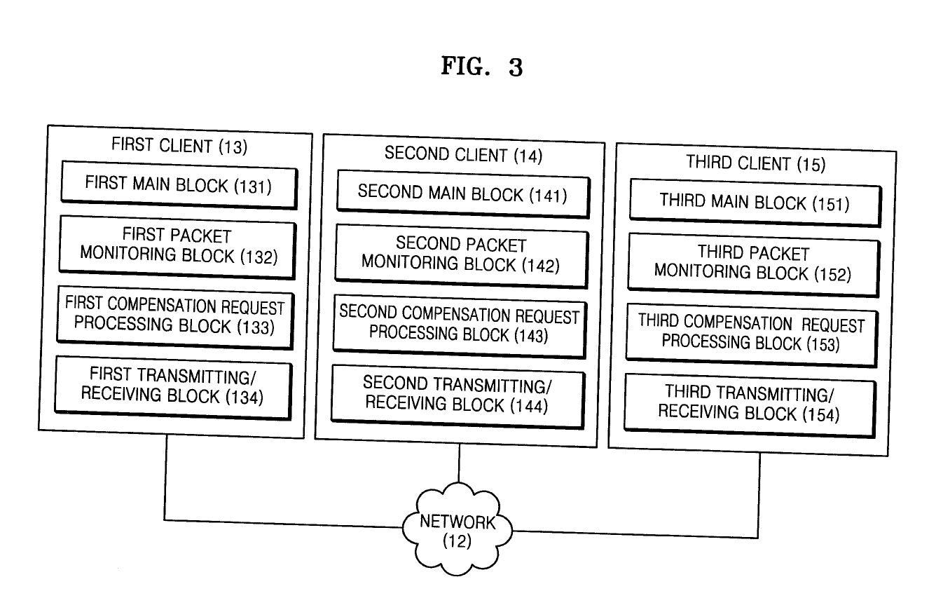

FIG. 3 is a block diagram illustrating in detail first through third clients 13 through 15 that constitute a system for compensating for packet loss, according to an exemplary embodiment of the present invention

The first client 13 includes a first main block 131, a first packet monitoring block 132, a first compensation request processing block 133, and a first transmitting/receiving block 134. The second client 14 includes a second main block 141, a second packet monitoring block 142, a second compensation request processing block 143, and a second transmitting/receiving block 144. The third client 15 includes a third main block 151, a third packet monitoring block 152, a third compensation request processing block 153, and a third transmitting/receiving block 143.

Each of the main blocks 131, 141, and 151 finds out the attributes of a packet received from a server (not shown) or from the other clients. That is, the main block determines whether the packet received via the transmitting/receiving block is a data packet, a packet requesting flag clearance, or a packet requesting packet compensation.

Each of the packet monitoring blocks 132, 142, and 152 monitors a sequence of data packets received from the server. The packet monitoring block determines whether packet loss occurs, based on continuity information contained in the header section of each of the data packets. If it is determined that one of the data packets has been lost, the packet monitoring block checks the packet importance information contained in a packet preceding or following the lost packet, to determine whether compensation for the lost packet is needed, depending on whether the lost packet contains important data, such as header data.

The functions performed by each of the compensation request processing blocks 133, 143, and 153 varies depending on whether the client that includes the compensation request processing block loses a packet.

The compensation request processing block of a client that has lost a packet transmits a request for compensation for the lost data packet to the other clients belonging to the same multicast group via the transmitting/receiving block.

The compensation request processing blocks of the other clients transmit the data packet to the client that lost the data packet, via the transmitting/receiving block, in a manner that does not cause transmission collision, in response to the request for the packet compensation.

Although not shown, each of the first through third clients 13 through 15 includes a buffer (or a packet pool) that stores received data packets, a storage unit (ROM, RAM, etc.), and a compensation flag.

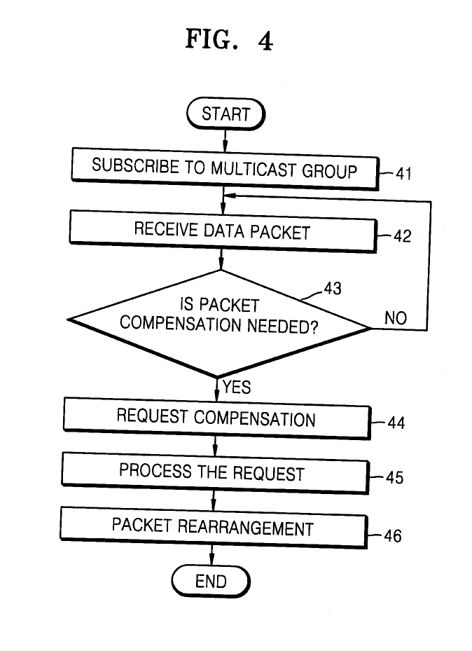

FIG. 4 is a flowchart illustrating a method of compensating for data packet loss, according to an exemplary embodiment of the present invention.

In operation 41, two or more clients subscribe to a multicast group. Two or more clients that desire to receive data packets (or multimedia content) from a server form a multicast group. The same multicast address is given to the clients.

In operation 42, the clients receive data packets from the server. The server transmits data packets each containing a specific multicast address, continuity information, and packet importance information via a network. Then, the clients subscribing to the multicast group in operation 41 receive the data packets. At the same time, each of the clients buffers a predetermined quantity of the data packets so that they can later reproduce the received data. The quantity of data packets that are to be buffered is determined by the transmission speed of a transmission channel, the capacity of the buffer, and so on.

In operation 43, each of the clients determines whether data packet compensation is needed. First, it is determined whether the data packets are continuous packets by checking the continuity information contained in the header of each of the data packets that the clients receive.

For convenience of explanation, it is assumed some data packets sent to the first client 13 illustrated in FIG. 3 are lost.

When one or more of the data packets transmitted to the first client 13, e.g., the third packet illustrated in FIG. 2, are lost, the first client 13 checks the header of a packet preceding or following a lost packet in order to determine the type of the lost packet. If the result of the check reveals that the lost packet contains important information, such as header data, which is necessary to reproduce A/V data, the first client 13 proceeds to operation 44. If not, the first client 13 returns to operation 42.

In operation 44, a compensation request packet (hereinafter referred to as a “compensation request”) is transmitted in order to compensate for the lost data packet. The first client 13 transmits the compensation request to the other clients 14 and 15 belonging to the same multicast group. The compensation request contains the continuity number, which is given to the lost data packet of the first client 13.

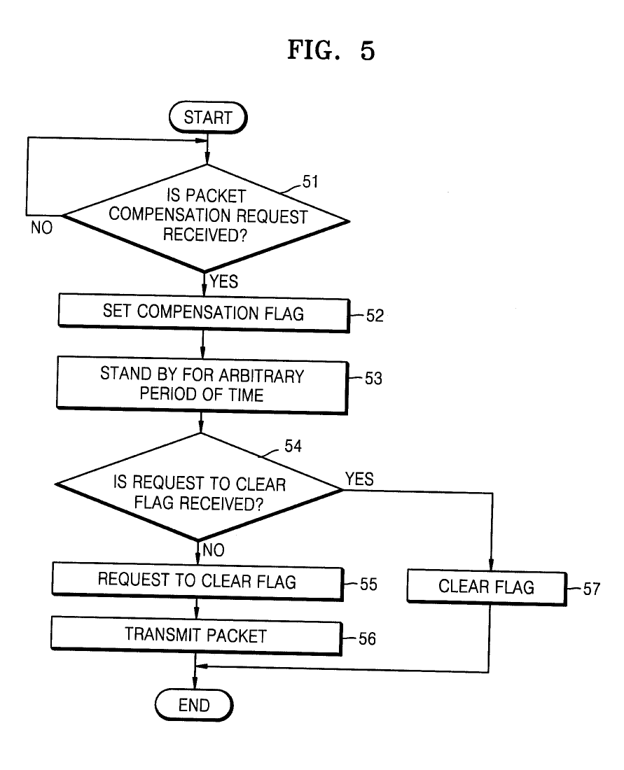

In operation 45, the compensation request is processed. The second and third clients 14 and 15 that receive the compensation request from the first client 13 transmit the lost data packet to the first client 13 in a manner that does not cause transmission collision. Operation 45 will be described later in greater detail with reference to FIG. 5.

In operation 46, the sequence of the packets is rearranged. The first client 13 receives the data packet from the client 14 or 15, and inserts it between the other buffered data packets (packet pool), based on the continuity number given to the data packet.

Then, the compensation for the lost data packet is completed.

FIG. 5 is a flowchart illustrating in detail operation 45 of the method illustrated in FIG. 4, according to an exemplary embodiment of the present invention.

As in FIG. 4, it is assumed that the first client 13 of FIG. 3 has lost a data packet and the other clients 14 and 15 will compensate for the lost packet.

In operation 51, the other clients 14 and 15 observe a transmission channel in order to determine whether a compensation request is received from the first client 13. Each of the clients 13 through 15 stores data packets of a cycle N in a storage unit (not shown). The storage unit may be RAM or ROM, and stores data packets in preparation for compensation of a lost data packet.

In operation 52, if it is determined that a compensation request is received from the first client 13, each of the second and third clients 14 and 15 sets its compensation flag. However, if a compensation request is not received, each of the clients 14 and 15 processes received packets and continuously observes the transmission channel (operation 51).

In operation 53, the clients 14 and 15 stand by for an arbitrary period of time. Each of the clients 14 and 15 receiving the compensation request waits for an arbitrary period of time before transmitting a packet requested by the first client 13, in order to prevent collision of the packet transmissions by the clients 14 and 15. To avoid the collision, each of the clients 14 and 15 generates a random number, and waits for a period of time corresponding to the generated number. In this example, it is assumed that the waiting period of the second client 14 is shorter than that of the third client 15.

In operation 54, each of the clients 14 and 15 determines whether a request to clear the compensation flag is received from the other client.

Since the waiting time of the second client 14 is shorter than that of the third client 15, the second client 14 does not receive a request to clear the compensation flag from the third client 15.

In operation 55, the second client 14 sends a request to the third client 15 to clear its flag. In operation 56, the second client 14 then reads from its storage unit a packet that is identical to the lost packet of the first client 13, and transmits that packet to the first client 13.

On the other hand, since the waiting time of the third client 15 is longer than that of the second client 14, the third client 15 receives a request to clear its flag from the second client 14. In operation 57, the third client 15 clears the flag set in operation 52.

The present invention can be embodied as computer readable code in a computer readable medium. Here, the computer readable medium may be any recording apparatus capable of storing data that is read by a computer system, e.g. a read-only memory (ROM), a random access memory (RAM), a compact disc (CD)-ROM, a magnetic tape, a floppy disk, an optical data storage device, and so on. The computer readable medium can be distributed among computer systems that are interconnected through a network, and the present invention may be stored and implemented as computer readable code in the distributed system.

According to the present invention, even if a client loses a data packet, the data packet can be compensated for, thus preventing reproduction of A/V data from being interrupted due to the loss of the data packet.

Also, since the other clients, instead of the server, compensate for the lost packet, it is possible to solve the problem of conventional methods, in which data transmission of a server is interrupted.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A client comprising:
a packet monitoring block which monitors whether first data packets transmitted from a server are lost; and
a compensation request processing block which transmits a first request for lost first data packets to other clients if the packet monitoring block detects a loss of the first data packets, and processes a second request for compensation of lost second data packets if the second request is received from at least one of the other clients.

2. The client of claim 1, wherein the client and the other clients are subscribed to a multicast group.

3. The client of claim 2, wherein the multicast group comprises:
a first multicast group to receive the first data packets from the server; and
a second multicast group which compensates for the loss of the first data packets.

4. The client of claim 1, further comprising a main block which determines attributes of the first data packets received from the server or the other clients.

5. The client of claim 1, wherein the first data packets comprise continuity information and packet importance information which have a predetermined periodicity.

6. The client of claim 1, further comprising a compensation flag which indicates whether the second request is received from the other clients.

7. The client of claim 1, further comprising a storage unit which stores received data packets for a response to the second request.

8. A system for compensating for data packet loss, the system comprising:
a server;
two or more clients which form at least one multicast group; and
a network which electronically connects the server and the clients,
wherein if one of the two or more clients loses data packets transmitted from the server, the lost data packets are compensated for from the other clients of the two or more clients.

9. A method of compensating for lost data packets, the method comprising:
receiving a data packet;
determining whether compensation for the data packet is needed;
if compensation for the data packet is needed, sending a request to other clients to compensate for the data packet; and
receiving a compensating data packet which compensates for the data packet from the other clients, and performing packet rearrangement.

10. The method of claim 9, further comprising subscribing to a multicast group.

11. The method of claim 9, further comprising buffering a plurality of data packets in order to reproduce multimedia data.

12. The method of claim 9, wherein the determining whether compensation for the data packet is needed comprises:
determining whether the data packet has been lost; and
determining an importance of the lost data packet.

13. The method of claim 12, wherein the determining whether the data packet has been lost is based on continuity information contained in the received data packets.

14. The method of claim 12, wherein the determining the importance of the lost packet is based on packet importance information contained in the received data packets.

15. A method of processing a request for compensation for a data packet, the method comprising:
a first client determining whether a request for data packet compensation is received from a second client; and
if the request is received, the first client transmitting a compensating data packet to the second client in a manner such that transmission by the first client does not collide with a transmission by a third client which has also received the request from the second client.

16. The method of claim 15, further comprising:
the first client setting a compensation flag indicating whether the request is received.

17. The method of claim 15, further comprising:
if the request is received, the first client standing by for an arbitrary period of time after determining whether the request is received and before transmitting the compensating data packet, in order to avoid a transmission collision with the third client.

18. The method of claim 17, wherein the transmitting the compensating data packet to the second client is performed only if a request to clear the compensation flag is not received from the third client.

19. The method of claim 17, further comprising:
the first client clearing the compensation flag when a request to clear the compensation flag is received from the third client.

20. The method of claim 15, wherein the second and the third clients store received data packets to respond to a request for data packet compensation.

21. A computer readable medium having embodied thereon computer executable instructions for implementing a method of compensating for a data packet, the method comprising:
determining whether compensation for the data packet is needed;
if compensation for the data packet is needed, requesting other clients to compensate for the data packet; and
receiving a compensation data packet that compensates for the data packet, and performing packet rearrangement.

22. A computer readable medium having embodied thereon computer executable instructions for implementing a method of processing a request for compensation for a data packet, the method comprising:
a first client determining whether a request for data packet compensation is received from a second client;
if the request is received, the first client transmitting a compensating data packet to the second client in a manner such that transmission by the first client does not collide with a transmission by a third client which also received the request from the second client.

23. A multicast data packet comprising:
a header section; and
a data section;
wherein the header section comprises continuity information and packet importance information.

24. The multicast data packet of claim 23, wherein the continuity information and the packet importance information indicate whether compensation for the data packet is needed if the data packet is lost.

25. The multicast data packet of claim 24, wherein the packet importance information indicates the type of the present data packet or of a subsequent data packet.
